(19) United States
(12) Patent Application Publication
(10) Pub. No.: US 2015/0368926 A1
(43) Pub. Date: Dec. 24, 2015

(54) Expandable Vehicle Cover Assembly

(71) Applicants: Fatima Herrera, Key Largo, FL (US); Mateo Munoz, Key Largo, FL (US)

(72) Inventors: Fatima Herrera, Key Largo, FL (US); Mateo Munoz, Key Largo, FL (US)

(21) Appl. No.: 14/308,868

(22) Filed: Jun. 19, 2014

(51) Int. Cl. E04H 15/38; E04H 6/04; B60J 11/04; E04H 15/48

(52) U.S. Cl. CPC E04H 15/38; E04H 15/48; E04H 6/04; B60J 11/04

(57) ABSTRACT

An expandable vehicle cover assembly for protecting a vehicle from dirt and moisture includes a pair of bases positionable on a support surface. The pair of bases are oriented on opposite sides of a vehicle. A central arm is operationally coupled between each of the pair of bases. The central arm extends over the vehicle. An end arm is operationally coupled between each of the pair of bases. The end arm is positionable in a deployed position so the end arm extends around an end of the vehicle. A canopy is coupled between the central and end arms. The canopy encompasses the vehicle when the end arm is positioned in the deployed position. The vehicle is protected from dirt and moisture.

### BACKGROUND OF THE DISCLOSURE

1. Field of the Disclosure

The disclosure relates to expandable vehicle cover devices and more particularly pertains to a new expandable vehicle cover device for expanding over a vehicle without making contact with the vehicle wherein the vehicle is protected from dirt and moisture.

2. Summary of the Disclosure

An embodiment of the disclosure meets the needs presented above by generally comprising a pair of bases positionable on a support surface. Each of the pair of bases is oriented on a respective side of a vehicle. A central arm is operationally coupled between the pair of bases. The central arm extends over the vehicle. An end arm is operationally coupled between each of the pair of bases. The end arm is positionable in a deployed position so the end arm extends around an end of the vehicle. A canopy is coupled between the central and end arms. The canopy encompasses the vehicle when the end arm is positioned in the deployed position. The vehicle is protected from dirt and moisture.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an expandable vehicle cover assembly according to an embodiment of the disclosure.

FIG. 2 is a left side view of an embodiment of the disclosure.

FIG. 3 is a front view of an embodiment of the disclosure.

FIG. 4 is a top view of an embodiment of the disclosure.

FIG. 5 is a right side view of an embodiment of the disclosure.

### DESCRIPTION OF THE PREFERRED EMBODIMENT

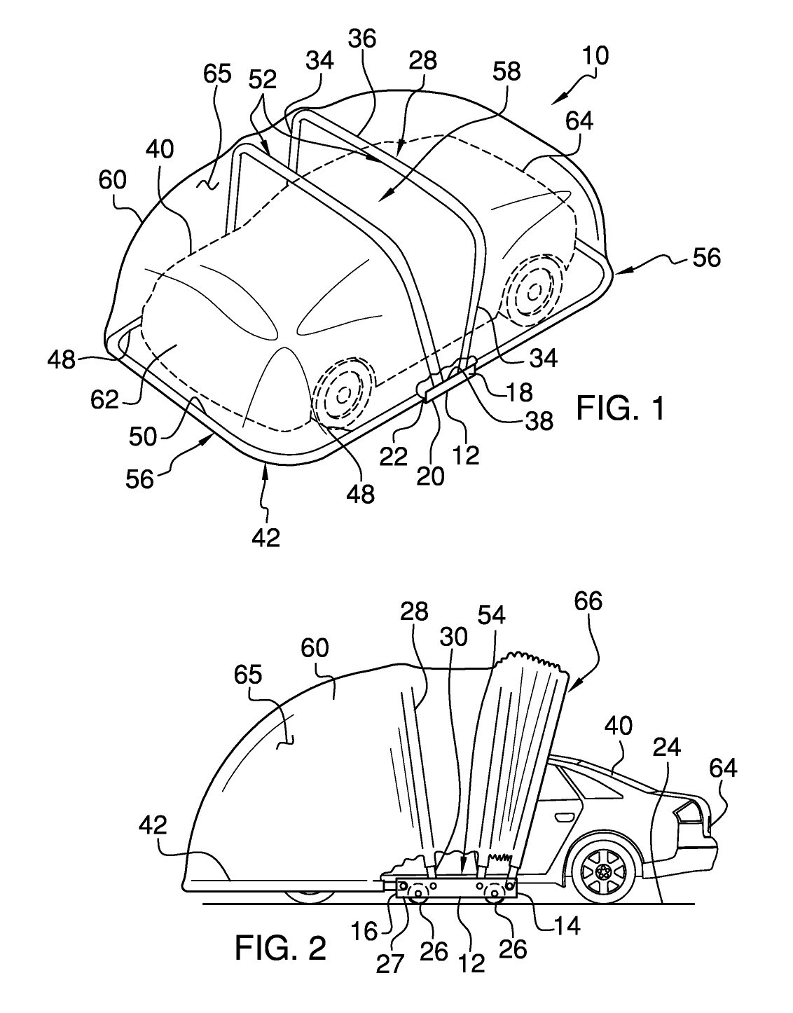

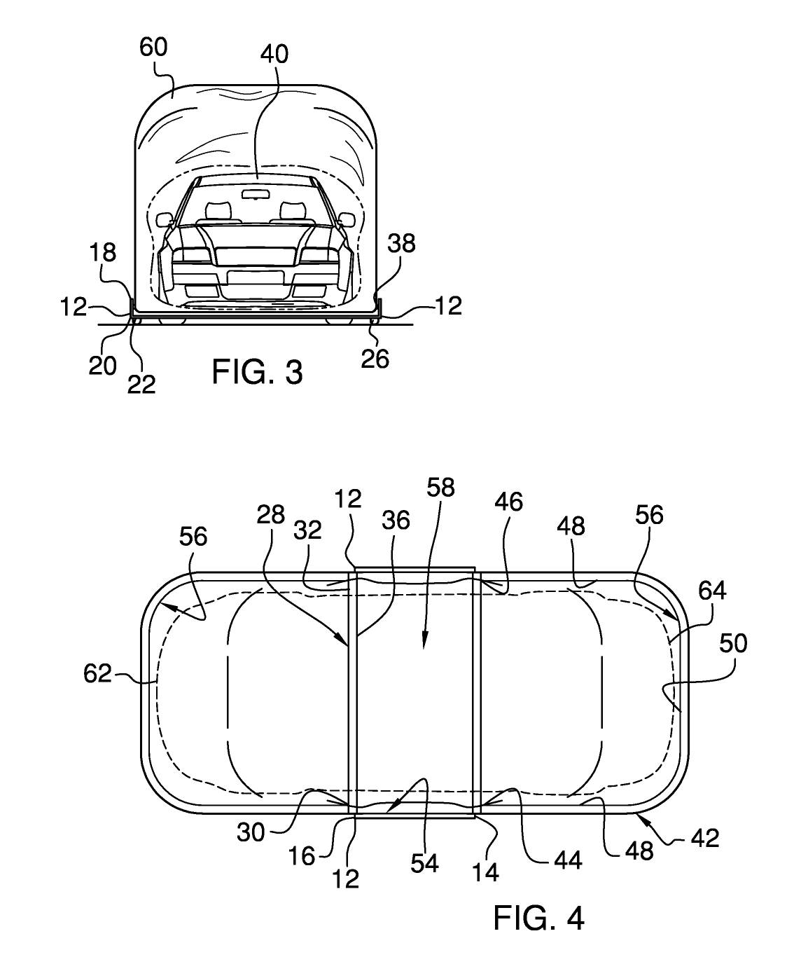

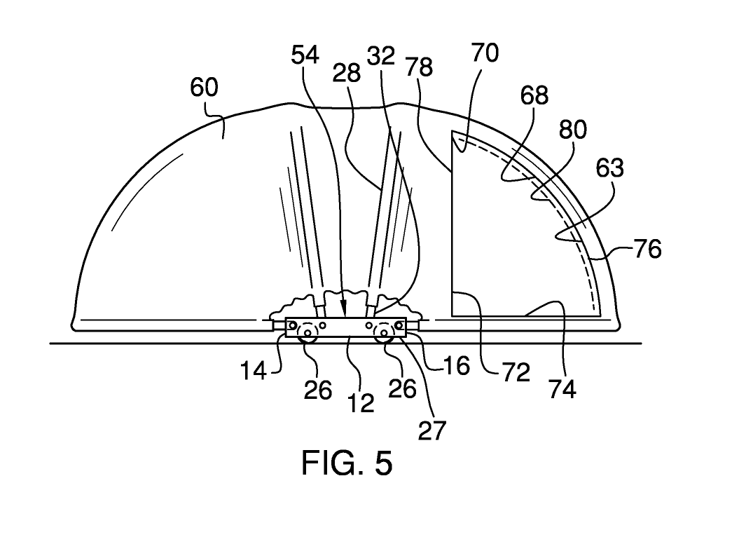

With reference now to the drawings, and in particular to FIGS. 1 through 5 thereof, a new expandable vehicle cover device embodying the principles and concepts of an embodiment of the disclosure and generally designated by the reference numeral 10 will be described.

As best illustrated in FIGS. 1 through 5, the expandable vehicle cover assembly 10 generally comprises a pair of bases 12 that each has a front end 14 and a back end 16. Each of the pair of bases 12 is elongated between the front 14 and back 16 ends. The pair of bases 12 each has a vertical side 18 of each of the pair of bases 12 extending upwardly from an outer edge 20 of a horizontal side 22 of each of the pair of bases 12. Each of the pair of bases 12 has an L-shape. Additionally, each of the pair of bases 12 is positionable on a support surface 24. The support surface 24 may be ground.

A pair of sets of wheels 26 is rotatably coupled to a bottom surface 27 of the horizontal side 22 of an associated one of each of the pair of bases 12. The pair of sets wheels 26 on the associated one of each of the pair of bases 12 abuts the support surface 24. Each of the pair of bases 12 are rolled along the support surface 24. Each of the pair of sets of wheels 26 may be oil resistant wheels of any conventional design.

A central arm 28 has a first end 30 and a second end 32 and the central arm 28 is elongated between the first 30 and second 32 ends. The central arm 28 has a pair of bends on it. The pair of bends is spaced apart. Moreover, the pair of bends defines a pair of longitudinal portions 34 of the central arm 28 extending downwardly from a lateral portion 36 of the central arm 28. The central 28 arm has a U-shape. The lateral portion 36 of the central arm 28 may have a length between 260 cm and 270 cm.

Each of the first 30 and second 32 ends of the central arm 28 is movably coupled to an inner surface 38 of the vertical side 18 of an associated one of each of the pair of bases 12. The central arm 28 extends upwardly from each of the pair of bases 12 and between each of the pair of bases 12. Each of the pair of bases 12 is spaced laterally apart so the pair of bases 12 are positionable on opposite sides of a vehicle 40. The vehicle 40 may be a passenger vehicle of any conventional design.

An end arm 42 has a primary end 44 and a secondary end 46. The end arm 42 is elongated between the primary 44 and secondary 46 ends. The end arm 42 has a pair of bends on it and the pair of bends is spaced apart. Moreover, the pair of bends defines a pair of vertical portions 48 of the end arm 42 extending downwardly from a horizontal portion 50 of the end arm 42. The end arm 42 has a U-shape. The horizontal portion 50 of the end arm 42 may have a length between 260 cm and 270 cm.

Each of the primary 44 and secondary 46 ends of the end arm 42 is movably coupled to the inner surface 38 of the vertical side 18 of an associated one of each of the pair of bases 12. The end arm 42 extends upwardly from each of the pair of bases 12. Additionally, the end arm 42 extends between each of the pair of bases 12.

The central arm 28 is one of a pair of the central arms 52. The pair of central arms 52 is each evenly spaced apart from a middle 54 of the vertical side 18 of each of the pair of bases 12. Additionally, the end arm 42 is one of a pair of the end arms 56. Each of the pair of end arms 56 is positioned proximate an associated one of the front 14 and back 16 ends of each of the pair of bases 12.

Each of the pair of the end arms 56 is positionable in a stored position. The pair of end arms 56 each extend upwardly from each of the pair of bases 12. Each of the pair of bases 12 is positioned on opposite sides of the vehicle 40 proximate a middle 58 of the vehicle 40. Moreover, each of the pair of end arms 56 and each of the pair of the central arms 52 straddles the vehicle 40.

A canopy 60 is coupled to each of the pair of the central arms 52 and each of the pair of the end arms 56. The canopy 60 extends between the first 30 and second 32 ends of the pair of center arms 52 and the primary 44 and secondary 46 ends of each of the pair of end arms 56. The canopy 60 may be comprised of a deformable and fluid impermeable material.

Each of the pair of the end arms 56 is positionable in a deployed position. Each of the pair of end arms 56 extends around an associated one of a forward end 62 and a rearward end 64 of the vehicle 40. The canopy 60 forms a dome shape when the pair of end arms 56 are positioned in the deployed positioned. Moreover, the canopy 60 encompasses the vehicle 40 so the vehicle 40 is protected from dirt and moisture.

The canopy 60 has an opening 63 extending through an outside surface 65 and an inside surface 66 of the canopy 60. An oblique side 68 of a bounding edge 70 of the opening 63 curves between each of a lateral side 72 and a lowermost side 74 of the bounding edge 70 of the opening 63. The opening 63 forms a quadrant of an oval. A user enters through the opening 63 to gain access to the vehicle 40 when the pair of end arms 56 is positioned in the deployed position.

A flap 76 is provided. A coupled edge 78 of the flap 76 is coupled to the lateral side 72 of the bounding edge 70 of the opening 63. The flap 76 completely covers the opening 63. A coupler 80 is coupled to a free edge of the flap. The coupler 80 engages the oblique side 68 of the bounding edge 70 of the opening 63 so the flap 76 is retained in a closed position. The flap 76 is positioned in an open position so the user may enter through the opening 63.

In use, the assembly 10 is positioned around the vehicle 40 so the pair of bases 12 are each positioned on opposite sides of the vehicle 40. Each of the pair of end arms 56 are positioned in the deployed position. The pair of end arms 56 are each positioned in the stored position when the assembly 10 is to be moved away from the vehicle 40. The user uses the opening 63 to gain access to the vehicle 40 when the pair of end arms 56 are in the deployed position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An expandable vehicle cover assembly for protecting the vehicle from dirt and moisture, said assembly comprising:
a pair of bases positionable on a support surface such that said pair of bases are oriented on opposite sides of the vehicle;
a central arm operationally coupled between each of said pair of bases such that said central arm extends over the vehicle, wherein said central arm is one of a pair of central arms, said pair of central arms each being evenly spaced apart from a middle of a vertical side of each of said pair of bases;
an end arm operationally coupled between each of said pair of bases, said end arm being positionable in a deployed position such that said end arm extends around an end of the vehicle, wherein said end arm is one of a pair of end arms, each of said pair of end arms being positioned proximate an associated one of a front end and a back end of each of said pair of bases;
a canopy coupled between said central and end arms, said canopy encompassing the vehicle when said end arm is positioned in said deployed position such that the vehicle is protected from dirt and moisture; and
a pair of wheels being rotatably coupled to a bottom surface of a horizontal side of an associated one of each of said pair of bases, each of said wheels being positioned between an associated one of said pair of end arms and an associated one of said central arms, said pair of wheels on the associated one of each of said pair of bases being configured for abutting the support surface such that each of said pair of bases are rolled along the support surface.

2. The assembly according to claim 1, wherein each of said pair of bases having a front end and a back end, each of said pair of bases being elongated.

3. The assembly according to claim 1, wherein said pair of bases each having a vertical side of each of said pair of bases extending upwardly from an outer edge of a horizontal side of each of said pair of bases such that said each of said pair of bases each has an L-shape.

4. (canceled)

5. The assembly according to claim 1, wherein said central arm having a first end and a second end, said central arm being elongated between said first and second ends.

6. The assembly according to claim 1, wherein said central arm having a pair of bends thereon, said pair of bends being spaced apart such that said pair of bends defines a pair of longitudinal portions of said central arm extending downwardly from a lateral portion of said central arm, said central arm having a U-shape.

7. The assembly according to claim 1, wherein each of a first end and a second end of said central arm being movably coupled to an inner surface of a vertical side of an associated one of each of said pair of bases such that said central arm extends upwardly from each of said pair of bases and between each of said pair of bases, each of said pair of bases being spaced laterally apart.

8. The assembly according to claim 1, wherein said end arm having a primary end and a secondary end, said end arm being elongated between said primary and secondary ends.

9. The assembly according to claim 1, wherein said end arm having a pair of bends thereon, said pair of bends being spaced apart such that said pair of bends defines a pair of vertical portions of said end arm extending downwardly from a horizontal portion of said end arm, said end arm having a U-shape.

10. The assembly according to claim 1, wherein each of a primary end and a secondary end of said end arm being movably coupled to an inner surface of a vertical side of an associated one of each of said pair of bases such that said end arm extends upwardly from each of said pair of bases and between each of said pair of bases.

11. (canceled)

12. (canceled)

13. The assembly according to claim 1, wherein said canopy being coupled to each of a pair of said central arms and each of a pair of said end arms such that said canopy extends between a first end and a second end of said pair of center arms and a primary end and a secondary end of each of said pair of end arms.

14. The assembly according to claim 1, wherein each of a pair of said end arms being positionable in a stored position having each of said pair of end arms extending upwardly from each of said pair of bases, each of said pair of bases being positioned on opposite side of the vehicle proximate a middle of the vehicle such that each of said pair of end arms and each of a pair of said central arms straddles the vehicle.

15. The assembly according to claim 1, wherein each of a pair of said end arms being positionable in said deployed position such that each of said pair of end arms extends around an associated one of a forward end and a rearward end of the vehicle, said canopy forming a dome shape when said pair of end arms are positioned in said deployed positioned.

16. An expandable vehicle cover assembly for protecting the vehicle from dirt and moisture, said assembly comprising:
a pair of bases having a front end and a back end, each of said pair of bases being elongated, said pair of bases each having a vertical side of each of said pair of bases extending upwardly from an outer edge of a horizontal side of each of said pair of bases such that said each of said pair of bases each has an L-shape each of said pair of bases being positionable on a support surface;
a central arm having a first end and a second end, said central arm being elongated between said first and second ends, said central arm having a pair of bends thereon, said pair of bends being spaced apart such that said pair of bends defines a pair of longitudinal portions of said central arm extending downwardly from a lateral portion of said central arm, said central arm having a U-shape, each of said first and second ends of said central arm being movably coupled to an inner surface of said vertical side of an associated one of each of said pair of bases such that said central arm extends upwardly from each of said pair of bases and between each of said pair of bases, each of said pair of bases being spaced laterally apart such that said pair of bases are positionable on opposite sides of the vehicle;
an end arm having a primary end and a secondary end, said end arm being elongated between said primary and secondary ends, said end arm having a pair of bends thereon, said pair of bends being spaced apart such that said pair of bends defines a pair of vertical portions of said end arm extending downwardly from a horizontal portion of said end arm, said end arm having a U-shape, each of said primary and secondary ends of said end arm being movably coupled to said inner surface of said vertical side of an associated one of each of said pair of bases such that said end arm extends upwardly from each of said pair of bases and between each of said pair of bases;
said central arm being one of a pair of said central arms, said pair of central arms each being evenly spaced apart from a middle of said vertical side of each of said pair of bases;
said end arm being one of a pair of end arms, each of said pair of end arms being positioned proximate an associated one of said front and back ends of each of said pair of bases;
each of said pair of said end arms being positionable in a stored position having each of said pair of end arms extending upwardly from each of said pair of bases, each of said pair of bases being positioned on opposite sides of the vehicle proximate a middle of the vehicle such that each of said pair of end arms and each of said pair of said central arms straddles the vehicle;
a canopy coupled to each of said pair of said central arms and each of said pair of said end arms such that said canopy extends between said first and second ends of said pair of center arms and said primary and secondary ends of each of said pair of end arms; each of said pair of said end arms being positionable in a deployed position such that each of said pair of end arms extends around an associated one of a forward end and a rearward end of the vehicle, said canopy forming a dome shape when said pair of end arms are positioned in said deployed positioned having said canopy encompassing the vehicle such that the vehicle is protected from dirt and moisture; and
a pair of wheels being rotatably coupled to a bottom surface of a horizontal side of an associated one of each of said pair of bases, each of said wheels being positioned between an associated one of said pair of end arms and an associated one of said central arms, said pair of wheels on the associated one of each of said pair of bases being configured for abutting the support surface such that each of said pair of bases are rolled along the support surface.
